(19) United States
(12) Patent Application Publication
(10) Pub. No.: US 2008/0173503 A1
(43) Pub. Date: Jul. 24, 2008

(54) FRAME FOR A LIFT

(76) Inventor: MARCO SCHUPFER, Rifferswil (CH)

Correspondence Address: SCHWEITZER CORNMAN GROSS & BONDELL LLP, 292 MADISON AVENUE - 19th FLOOR, NEW YORK, NY, 10017, US

(21) Appl. No.: 12/018,896

(22) Filed: Jan. 24, 2008

(30) Foreign Application Priority Data
Jan. 24, 2007 (EP) 07 101111.8

(51) Int. Cl. B66B 11/02; B66B 5/16; F16N 7/16

(52) U.S. Cl. 187/401; 187/356; 184/21

(57) ABSTRACT

A frame for a lift, such as a double-decker lift, has at least one cage carried by a common, rectangular frame. The frame consists of an upper yoke, a center yoke, a lower yoke and side panels. First roller guides are provided for each lift guide rail ends of the frame longitudinal side or at the upper and lower yokes. A second roller guide for each guide rail is provided at the center yoke. The second roller guides improve the stiffness and increase the natural frequency of the frame.

The present invention relates to a frame for a lift with at least one lift cage arranged at the frame, wherein the frame is movable along guide rails and has at the end of the frame longitudinal side first guides per guide rail for guidance of the frame.

### BACKGROUND OF THE INVENTION

A lift cage movable in a lift shaft is guided during movement along guide rails. Sliding guides or roller guides arranged at the corners of the cage frame slide or roll along precisely oriented guide rails and impart to the lift cage secure retention in the horizontal directions. In the case of double-story cages there is usually provided a frame for both cages, consisting of an upper yoke, a center yoke and a lower yoke, wherein frame suspension takes place at the upper yoke; the upper cage is carried by the center yoke and the lower cage by the lower yoke. Roller guides arranged at the corners of the frame guide the entire frame along the guide rails.

### BRIEF DESCRIPTION OF THE INVENTION

It is a purpose of the present invention to provide a frame which can be guided in stable manner along the guide rails. In accordance therewith a lift cage or counterweight frame has first guides located at an end of the longitudinal side for guidance along the guide rails and at least one further guide for each rail also located along the longitudinal side.

The advantages achieved by the invention are substantially to be seen in that, particularly in the case of a frame of a double-decker or multi-decker cage or a counterweight, the natural frequency of the frame and its stiffness are increased. Low natural frequencies induced by long frames can be eliminated and thus travel comfort improved. In addition, frame stiffness is improved without requiring a heavier construction of the frame.

### BRIEF DESCRIPTION OF THE DRAWING

The present invention is explained in more detail in the following detailed description of a preferred but nonetheless illustrative embodiment thereof, in association with the accompanying figures, in which:

FIG. 1 is a perspective view of a double-decker lift embodying the invention;

FIG. 2 is a detail view of portion A in FIG. 1 of the double-decker lift;

FIG. 3 is a detail view of portion B in FIG. 1 of the double-decker lift; and

FIG. 4 is a plan view of a second guide in the form of a sliding emergency guide.

### DETAILED DESCRIPTION OF THE INVENTION

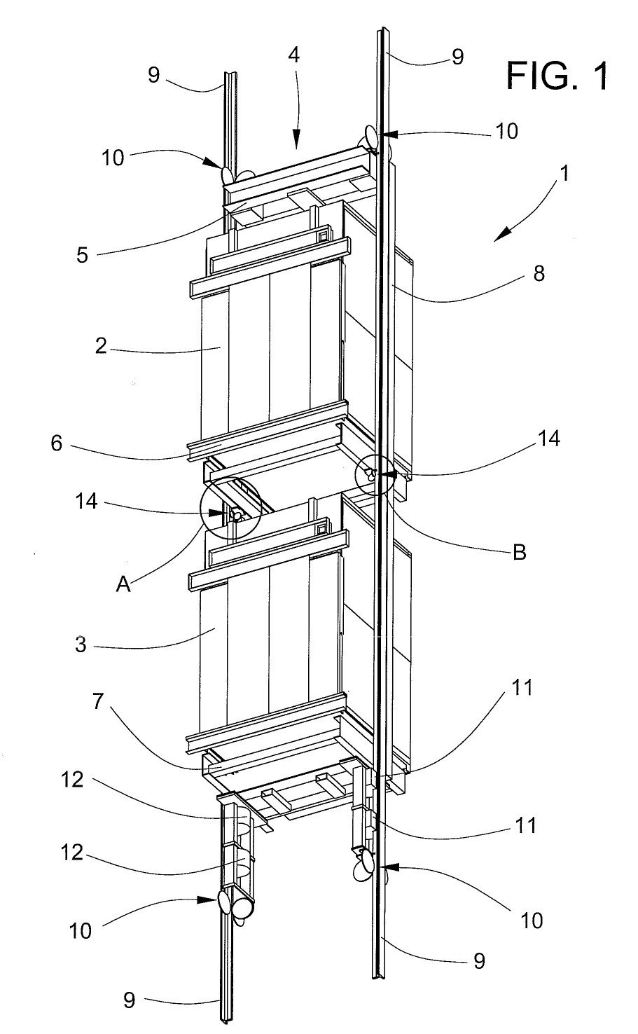

FIG. 1 shows a double-decker lift with an upper cage 2 and a lower cage 3, which are carried by a common rectangular frame 4. The frame 4 consists of an upper yoke 5, a center yoke 6, a lower yoke 7 and side panels 8, wherein the side panels 8 are connected with the upper yoke 5, the center yoke 6 and the lower yoke 7. The frame longitudinal sides are formed in each instance by a side panel 8 and extend parallel to the guide rails 9. The guide rails 9 are arranged at shaft walls (not illustrated). The upper cage 2 is carried by the center yoke 6 and the lower cage 3 is carried by the lower yoke 7.

The frame 4 is suspended at the upper yoke 5, at which, for example, a support means connection or a deflecting roller is arranged. The upper yoke can also be of triangular construction, wherein the illustrated yoke 5 forms one side of the triangle. The triangle can be equilateral or equal-sided. The support means end connection or the deflecting roller is in this variant arranged at the top corner of the triangle, opposite the yoke 5. The support means is guided by way of a drive pulley and/or a deflecting pulley and is connected with a counterweight. The frame 4 and the counterweight move in opposite senses. The support means, support means end connection, drive pulley, deflecting rollers and counterweight, as known in the art, are not illustrated. A first roller guide 10 is provided per guide rail 9 at each end of the corresponding frame longitudinal side, or at the upper yoke 5 and the lower yoke 7. Each roller guide 10 consists of a roller 10.1, which rolls on the end face of the free limb guide rail 9, and of a respective roller 10.2, 10.3 rolling along each side of the free limb. The roller guide 10 can also consist, for example, of six rollers. In addition, safety devices, such as a safety brake 11 or a buffer 12, are arranged at the lower yoke 7.

A second roller guide 14 is provided at the center yoke 6 per guide rail 9, details of which are illustrated in detail views A and B. The roller guides 14 improve the stiffness and increase the natural frequency of the frame 4.

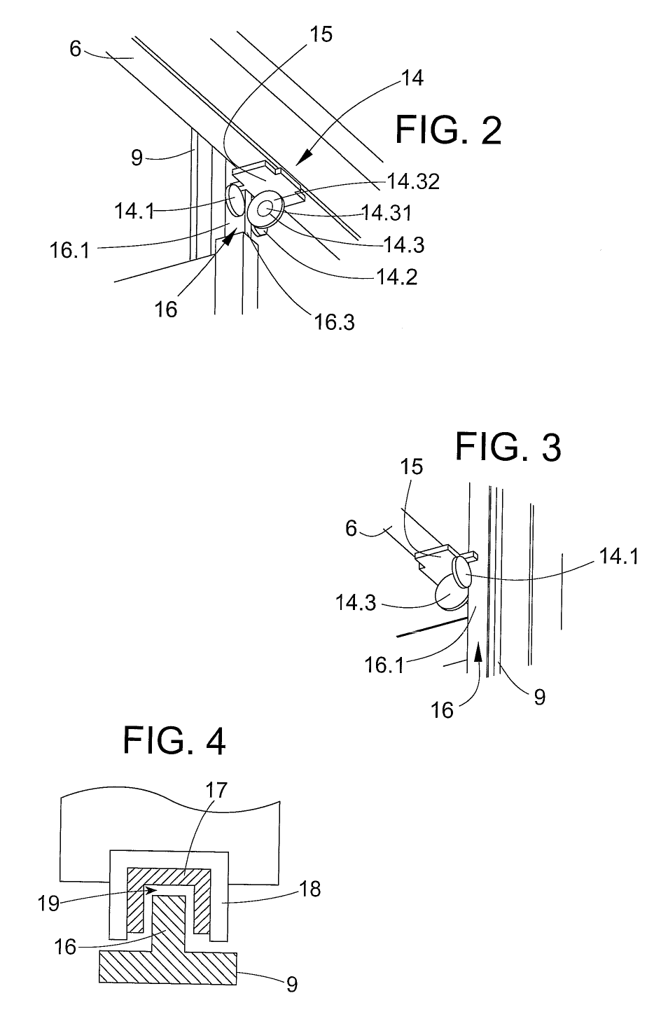

FIG. 2 shows detail view A of the double-decker lift 1. The second roller guide 14 of a guide rail 9 is arranged at the center yoke 6 by means of a bracket 15 and consists of three rollers. Provided at the free limb 16 of the guide rail 9 is a first roller 14.1 which rolls on one limb side 16.1, a second roller 14.2 which rolls on the other limb side, and a third roller 14.3 which rolls on an end face 16.3 of the free limb 16. The rollers 14.1, 14.2, 14.3 may consist of a tire which is arranged on a wheel rim and which rolls along the free limb 16 of the guide rail 9. Roller 14.3 depicts rim 14.31 and tire 14.32. The roller guide 14 can also consist of, for example, six rollers.

FIG. 3 shows detail view B with the second roller guide 14, arranged at the center yoke 6. The roller guides 14 of both guide rails 9 are of the same construction.

Instead of the second roller guide 14 it is also possible to provide a sliding guide. As shown in FIG. 4, a sliding guide may consist of a sliding lining 17 which is held by means of a U-profile 18 and which embraces the free limb 16. The sliding lining can also be constructed to serve as a lubricant dispenser. Further roller guides or sliding guides can be provided along the frame longitudinal side per guide rail. As further depicted in FIG. 4, the further guides can also be constructed as emergency guides which do not have any contact with the guide rail 9 during normal operation if substantial forces, for example in the case of earthquakes, act on the frame 4 and cause substantial deflection thereof the emergency guides, for example as sliding guides, additionally guide the frame 4 at the guide rails 9. The emergency guides can also be constructed as U-profiles that embrace the free limb 16 with a spacing 19 during normal operation. The U profile can be made of metal or plastic.

The above-illustrated arrangement of the guides at the frame can also be used with frames for only one cage or with a cage for a counterweight.

I claim:

1. A frame for a lift cage or counterweight, wherein the frame is movable along guide rails and has, at opposed ends of frame longitudinal sides, first guides for a guide rail for guidance of the frame, characterised in that at least one further guide is provided along the frame longitudinal side between the end for the corresponding guide rail.

2. The frame according to claim 1, characterised in that the first and further guides are roller guides or sliding guides.

3. The frame according to claim 2, characterised in that the roller guides comprise a roller constructed as a wheel rim with a tire located to roll along a free limb of the guide rail.

4. The frame according to claim 2, characterised in that the sliding guide has a slide lining which is held by means of U profile and which embraces a free limb of the guide rail.

5. The frame according to claim 4, characterised in that the slide lining is constructed as a lubricant dispenser.

6. The frame according to claim 1 or 2, wherein at least one of the further guides is constructed as an emergency guide which for guiding the frame at the guide rails when substantial forces act on the frame.

7. The frame according to claim 6, characterised in that the emergency guide is constructed as a U profile which embraces a free limb of the guide rail in a spaced manner during normal operation of the lift.

8. The frame according to claim 7, characterised in that the U profile is constructed of metal or plastic.

9. A lift cage or counterweight with a frame according to claim 1 or 2.

10. A lift with at least one of a lift cage and counterweight according to claim 9.
